(19) United States
(12) Patent Application Publication
(10) Pub. No.: US 2008/0298732 A1
(43) Pub. Date: Dec. 4, 2008

(54) Unitized Single Row Bearing with Reverse Thrust Capabilities

(75) Inventors: Mircea Gradu, Massillon, OH (US); Timothy L. Schlernitzauer, Canton, OH (US); Steven A. Roman, North Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: The Timken Company, Canton, OH (US)

(21) Appl. No.: 12/158,198

(22) PCT Filed: Dec. 21, 2006
(86) PCT No.: PCT/US2006/048905

§ 371 Date: Jun. 19, 2008

Related U.S. Application Data
(60) Provisional application No. 60/752,744, filed on Dec. 21, 2005.

(51) Int. Cl. F16C 19/54

(52) U.S. Cl. 384/452

(57) ABSTRACT

An antifriction bearing A capable of transferring radial loads as well as thrust in both axial directions. The bearing A comprises an outer race (2) having a primary raceway (20) and a back face (22), the back face (22) further having a reverse thrust raceway (26) beyond the small end of the primary raceway (20). The bearing A also comprises an inner race (4) having another primary raceway (30). Rolling elements (6) are arranged in a single row between the primary raceways (20, 30) of the races (2, 4). A backing plate is carried by the inner race (4) and presented opposite the back face (2)2 of the outer race (2). An antifriction device (10) is located between the reverse thrust raceway (42) of the backing plate (8) and the reverse thrust raceway (26) of the outer race (2).

### CROSS-REFERENCE TO RELATED APPLICATIONS

This application claims priority to U.S. Application No. 60/752,744 filed on Dec. 21, 2005 and is incorporated herein by reference.

### TECHNICAL FIELD

The present disclosure relates in general to an antifriction bearing, and in particular, to an antifriction bearing capable of transferring radial loads along an axis of rotation as well as thrust in both axial directions while minimizing friction of the bearing.

### BACKGROUND ART

In its most basic form, a tapered roller bearing has a cone (inner race) and a cup (outer race), each provided with a tapered raceway, and in addition, a single row of tapered rollers located between the raceways of the cone and cup. The bearing will transfer radial loads and in addition thrust, but only in one axial direction. In order to accommodate thrust in both axial directions, one normally employs two single roller bearings arranged in opposition or else a double row tapered roller bearing, with the rollers of its two rows organized in opposition. Either of these arrangements occupies considerably more space than the basic single row tapered roller bearing. These space constraints hold true for angular contact ball bearings.

To be sure, there exists a single row tapered roller bearing, known as a Unit-Bearing, that has the capacity to take reverse thrust, and in that sense this bearing accommodates thrust in both axial directions. The thrust in one direction seats the rollers against the tapered raceways and the thrust transfers through the raceways. The reverse thrust in the opposite direction brings the ends of the rollers against thrust ribs at opposite ends of the cone and cup, so that the reverse thrust transfers generally longitudinally through the rollers. The former accommodates thrust of a considerably greater magnitude than the latter, so a Unit-Bearing is normally oriented so as to transfer the greatest torque through the raceways. U.S. Pat. No. 3,420,589 discloses a basic Unit-Bearing, whereas U.S. Pat. No. 5,735,612 shows a Unit-Bearing in a semi-floating rear axle, both patents being incorporated herein by reference.

Many rear wheel drive vehicles, typically large passenger cars, sport-utility vehicles and light trucks, are equipped with semi-floating rear axle shafts which rotate in solid axle housings. In the typical arrangement a single housing contains a differential and two axle shafts that extend through the housing from the differential, emerging from the housing at its ends. Here the axle shafts are fitted with drive flanges to which brake drums or disks and the road wheels are fastened. At each of its ends the housing contains an antifriction bearing, and the two axle shafts extend through and rotate within these bearings. In other words, the bearings support the semi-floating axle shafts in the housing. When installed at the end of a semi-floating rear axle for an automobile or light truck, a Unit-Bearing should be oriented such that it takes the thrust load through its raceway when on the outside of a turn and through its ribs on the inside of a turn.

The traditional Unit-Bearing, however, when transferring reverse thrust through its thrust ribs, generates a considerable amount of friction between the ends of the rollers and the ribs. Moreover, the traditional Unit-Bearing has limited thrust capacity in that direction of transfer.

### BRIEF DESCRIPTION OF THE DRAWINGS

In the accompanying drawings which form part of the specification:

FIG. 1 is a sectional view of an antifriction bearing constructed in accordance with and embodying the present disclosure;

FIG. 2 is a cross sectional view taken along line “2-2” of FIG. 1 illustrating components of the antifriction bearing of FIG. 1 including an antifriction device constructed in accordance with and embodying the present disclosure;

FIG. 3 is a cross sectional view of the antifriction bearing of FIG. 1 positioned within a portion of an automotive axle;

FIG. 4 is a cross sectional view of another embodiment of the antifriction bearing having another antifriction device constructed in accordance with and embodying the present disclosure;

FIG. 5 is a cross sectional view of the antifriction bearing of FIG. 4 positioned within a portion of an automotive axle;

FIG. 6 is cross sectional view of another embodiment of the antifriction bearing having another antifriction device constructed in accordance with and embodying the present disclosure;

FIG. 7 is cross sectional view of another embodiment of the antifriction bearing having another antifriction device constructed in accordance with and embodying the present disclosure;

FIG. 8 is cross sectional view of another embodiment of the antifriction bearing having another antifriction device constructed in accordance with and embodying the present disclosure

FIG. 9 is cross sectional view of another embodiment of the antifriction bearing having another antifriction device constructed in accordance with and embodying the present disclosure; and

FIG. 10 is cross sectional view of another embodiment of the antifriction bearing having another antifriction device constructed in accordance with and embodying the present disclosure.

Corresponding reference numerals indicate corresponding parts throughout the several figures of the drawings.

### BEST MODE FOR CARRYING OUT THE INVENTION

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best modes of carrying out the invention.

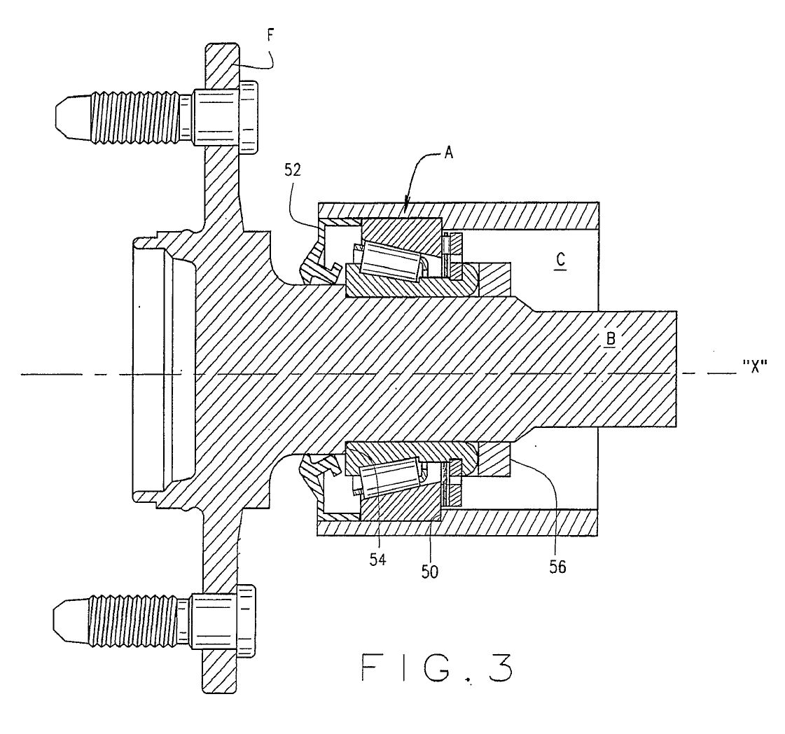

Referring now to the drawings, a single row tapered roller bearing A supports a shaft B in a housing C, (FIG. 3) enabling the shaft B to rotate about an axis of rotation “X” within the housing C. The bearing A not only confines the shaft B radially within the housing C, but also positions it axially, preventing it from being displaced in either axial direction, all while enabling the shaft B to rotate about the axis of rotation “X” with minimum friction. The bearing A not only transfers radial loads between the housing C and shaft B, but also thrust in both axial directions.

The housing C may be an axle housing that is attached to a suspension system of an automotive vehicle (not shown), whereas the shaft B may extend through the housing C and at the open end of a housing C is provided with a flange to which a road wheel (not shown) is attached. The shaft B transmits torque to its road wheel to propel the vehicle. As such, the bearing A, shaft B and housing C may form a semi-floating axle.

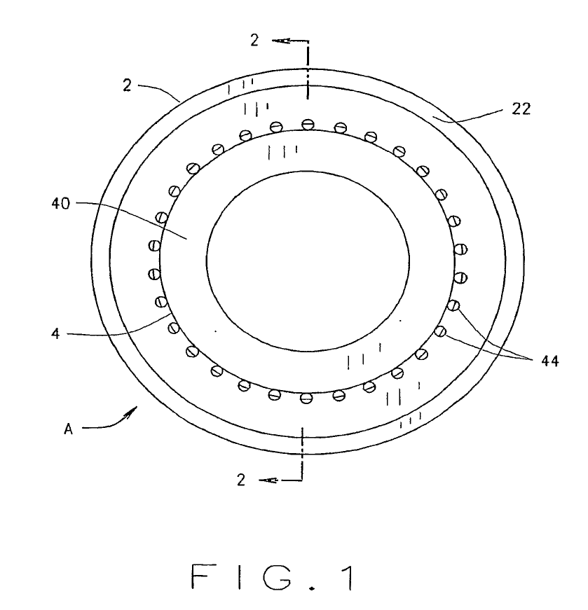

Turning now to the bearing A, it includes (FIGS. 1 & 2) an outer race in the form of a cup 2, and inner race in the form of a cone 4 located generally within the cup 2, primary rolling elements in the form of tapered rollers 6 located in a single row between the cup 2 and cone 4, a backing plate 8 at one end of the cone 4, and an antifriction device in the form of secondary rolling elements 10. In one embodiment, the rolling elements 10 comprise needle rollers located between the end of the cup 2 and the backing plate 8. In addition, the bearing A has a primary cage 12 for positioning the tapered rollers 6 and a secondary cage 14 for positioning the needle rollers 10.

The cup 2 contains a tapered raceway 20 that is presented inwardly toward the axis of rotation “X”. The cup 2 includes a back face 22 at the small end of the raceway 20 and a front face 24 at the large end of the tapered raceway 20. The cup 2 also has a reverse-thrust raceway 26 that may lie flush with the back face 22. The exterior of the cup 2 is cylindrical and of a size that enables the cup 2 to fit snuggly, preferably with an interference fit, into the housing C.

The cone 4 encircles the shaft B, preferably with an interference fit. The cone 4 has a tapered raceway 30 that is presented outwardly away from the axis of rotation “X” and toward the tapered raceway 20 of the cup 2, tapering in the same direction as the raceway 20. The tapered raceway 30 of the cone 4 is presented toward the tapered raceway 20 of the cup 2. Indeed, the two tapered raceways 204 and 30, if extended to their respective apices, will have those apices located at essentially the same point along the axis of rotation “X” of the bearing A.

At the large end of the raceway 30, the cone 4 has a thrust rib 32 that projects outwardly beyond the raceway 30. The thrust rib 32 leads out to another back face 34 that is presented axially in the direction opposite to that in which the cup back face 22 is presented. The raceway 30 lies somewhat depressed between the thrust rib 32 and a retaining rib 36 at the small end of the raceway 30. The retaining rib 36 leads out to a shoulder 38 against which the backing plate 8 fits. Beyond the shoulder 38, the cone 4 has a formed end 40 which turns outwardly behind the backing plate 8 to capture the backing plate 8 between it and the shoulder 38.

The tapered rollers 6 lie in a single row between the cup 2 and cone 4. Along their tapered side faces, the tapered rollers 6 contact the raceways 20 and 30 of the cup 2 and cone 4, respectively. Generally speaking, line contact exists between the side faces of the tapered rollers 6 and the tapered raceways 20 and 30. Since the raceways 20 and 30 have their apices at a common point along the axis of rotation “X”, the tapered rollers 6 are on apex, and as a consequence essentially pure rolling contact occurs between the side faces of the tapered rollers 6 and raceways 20 and 30 as the cone 4 rotates within the cup 2 and the tapered rollers 6 roll along the raceways 20 and 30. The tapered rollers 6 at their large ends bear against the thrust rib 32 of the cone 4, and indeed, the thrust rib 32 prevents the tapered rollers 6 from migrating out of the annular space between the cup 2 and cone 4. The primary cage 12 also occupies that space where it rides over center on the tapered rollers 6 and maintains a uniform spacing between the tapered rollers 6.

The backing plate 8 fits over the end of the cone 4 where it is captured between the shoulder 38 and the formed end 40 and in turn is backed by the formed end 40. It has a reverse-thrust raceway 42 that is presented toward, yet spaced from, the reverse-thrust raceway 26 of the cup 2. Both the raceways 26 and 42 lie in planes that are perpendicular to the axis of rotation “X”. Inside the raceway 42 and beyond the formed end 40, the backing plate 8 has oil ports 44 that pass axially through it.

The needle rollers 10 occupy the space between the reverse-thrust raceway 26 of the cup 2 and the reverse-thrust raceway 42 of the backing plate 8. Indeed, the backing plate 8 at its raceway 42, the cup 2 at its raceway 26, and the needle rollers 10 function as a thrust bearing for transferring thrust in one direction between the cup 2 and cone 4. The secondary cage 14 also occupies the space between the backing plate 8 and cup 2. It is piloted on the retaining rib 36 of the cone 4 and maintains the needle rollers 10 directed radially with respect to the axis of rotation “X” and with uniform spacing between them. The needle rollers 10 and their cage 14 leave an annular segment of the cup back face 22 exposed for transferring thrust to the cup 2, and the same holds true for the backing plate 8.

Initially, the cone 4 does not have the formed end 40, but instead has an extended deformable end that projects axially with its outside diameter being equivalent to the diameter that leads up to the shoulder 38. Indeed, the surfaces, represented by the two diameters, are indistinguishable.

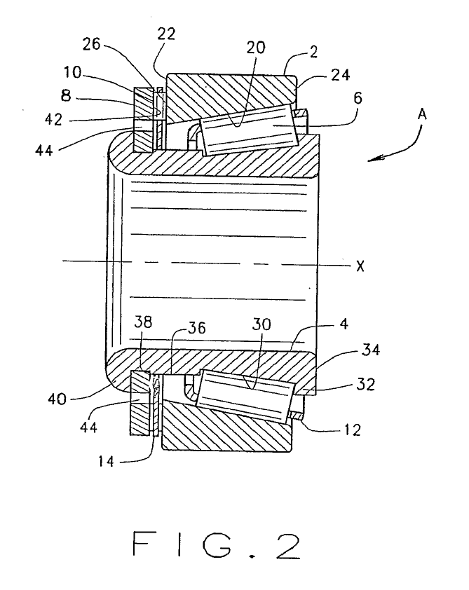

To assemble the bearing A, the tapered rollers 6 and the primary cage 12 are installed over the cone 4. Then the cup 2 is installed over the tapered rollers 6. Relative rotation between the cup 2 and cone 4 causes the tapered rollers 6 to seat against the raceways 20 and 30 and against the thrust rib 32. Next the needle rollers 10, while confined within the secondary cage 14, are brought against the reverse-thrust raceway 26 of the cup 2. Then the backing plate 8 is advanced over the deformable end of the cone 4 to the shoulder 38. At this juncture, the deformable end is deformed outwardly against the backing plate 8 and thus converted into the formed end 40. The deformation captures the plate 8 between the formed end 40 and the shoulder 38 of the cone 4. U.S. Pat. No. 6,443,622, which is incorporated herein by reference, discloses a process for converting the extended deformable end of the cone 4 into the formed end 40. As shown in FIGS. 2 and 3, the antifriction device 10 is located between the reverse thrust raceway 42 of the backing plate 8 and the reverse thrust raceway 26 of the outer race 2 to transfer thrust between the primary races 20, 30 in the axial direction that tends to unseat the rolling elements 6 from the primary raceways 20, 30.

In operation, the shaft B rotates within the housing C with radial loads being transferred from the housing C to the shaft B through the bearing A. As a consequence of the rotation and radial load, the tapered rollers 6 roll along the raceways 20 and 30 with their large end faces against the thrust rib 32. The bearing A transfers radial loads through its tapered rollers 6 at the raceways 20 and 30 of the cup 2 and cone 4, respectively. Thrust applied directly to the back face 22 of the cup 2 beyond the needle rollers 10 and resisted at the back face 34 of the cone 4 or vice versa, transfers through the tapered rollers 6 along the tapered raceways 20 and 30 with minimal friction. Thrust applied at the front face 24 of the cup 2 and resisted at the formed end 40 of the cone 4 or vice versa transfers through the needle rollers 10, again with minimal friction.

Thus, should the shaft B encounter a thrust load which urges drive flange F (FIG. 3) toward the end of the housing C, the tapered rollers 6 will transmit that load through the raceways 20 and 30, the loads in effect passing normally through the tapered rollers 6 and seating the tapered rollers 6 more firmly between the raceways 20 and 30. Thrust loads in the opposite direction, that is the direction which draws the drive flange away from the end of the housing C, are likewise transmitted through the tapered rollers 6, but instead of normally, these loads pass generally axially through the tapered rollers 6 and are resisted at the thrust rib 32. The bearing B should be mounted such that the lighter thrust loads are taken through the rib 32 and the heavier thrusts through the raceways 20 and 30.

As shown in FIG. 3, the bearing A may be installed between the shaft B and the housing C with the cup 2 received in the housing C and the cone 4 around the shaft B. The back face 22 of the cup 2 bears against a shoulder 50 in the housing C, whereas the front face 24 lies opposite a restraining device 52 that is fitted into the housing C. The back face 34 of the cone 4 bears against a shoulder 54 on the shaft B, whereas the formed end 40 is against a collar 56 that is forced over the shaft B. Thus, the bearing A is confined axially in the housing C and axially on the shaft B.

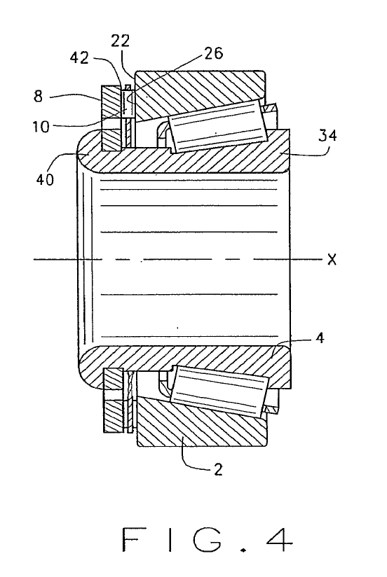

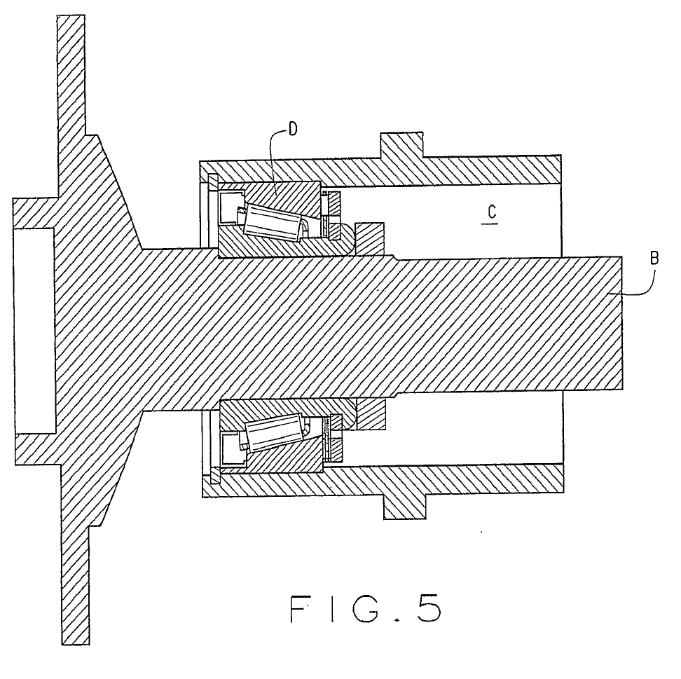

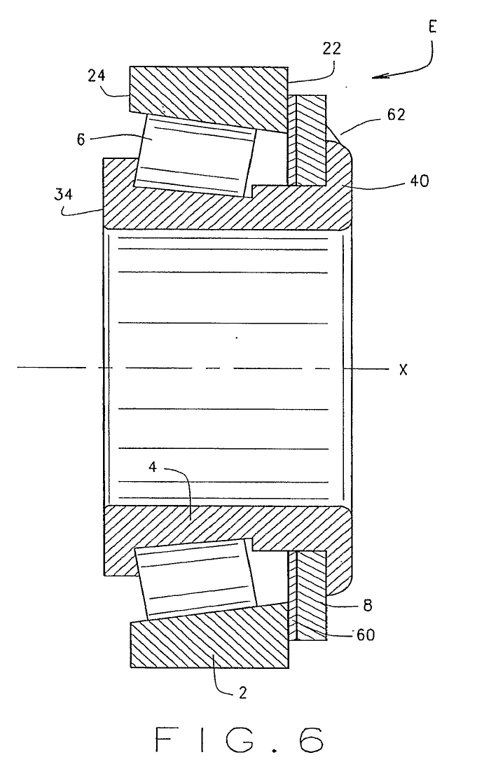

Modified bearing D (FIGS. 4 and 5) may include the reverse thrust raceways 26, 42 and needle rollers 10 as the antifriction device. In another modified bearing E (FIG. 6), the needle rollers 10 are replaced by a washer 60 formed from a low friction material such as a phenolic resin. The washer 60 is bonded firmly to the backing plate 8 such that is presented toward the back face 22 of the cup 2. The backing plate 8 may be secured permanently to the formed end 40 at a weld 62 to present it from rotating on the cone 4.

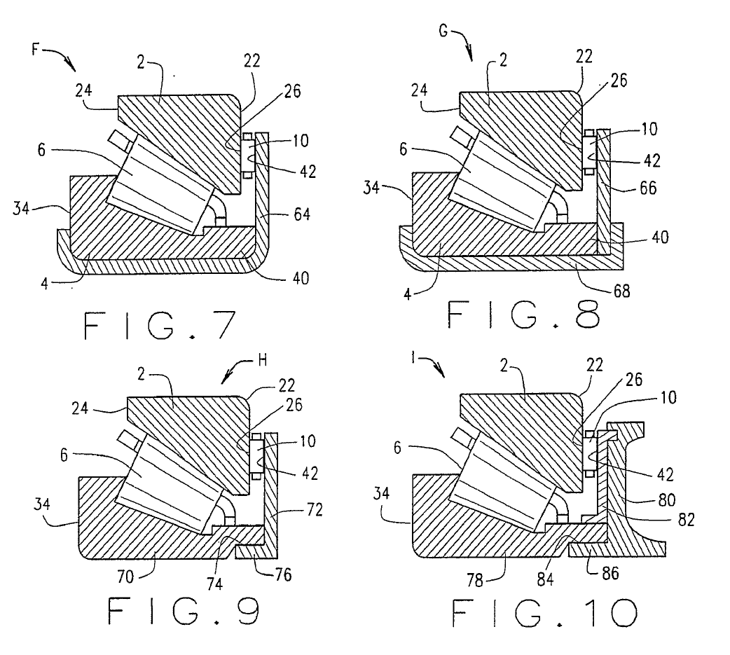

In another modified bearing F (FIG. 7), backing plate 64 fits partially around the cone 4. As shown, the backing plate 64 fits around end 40, under the cone 4 and partially around back face 34 of the cone 4. In one embodiment, the backing plate 64 comprises a stamping of needle bearing quality material. Backing plate 64 includes reverse thrust raceway 42 that is presented toward, yet spaced from, the reverse thrust raceway 26 of the cup 2. The needle rollers 10 occupy the space between the reverse-thrust raceway 26 of the cup 2 and the reverse-thrust raceway 42 of backing plate 64. Indeed, the backing plate 64 at its raceway 42, the cup 2 at its raceway 26, and the needle rollers 10 function as a thrust bearing for transferring thrust in one direction between the cup 2 and cone 4.

In another modified bearing G (FIG. 8), bearing G includes a modified backing plate 66 and compression member 68. As shown, the backing plate 66 extends along the side of end 40 of the cone 4. The compression member 68 fits around the lower end of backing plate 66, under the cone 4 and partially around the back face 34 of cone 4. The compression member 68 captures the backing plate 66 against the cone 4 to radially and axially confine the backing plate 66. In one embodiment, the compression member 68 comprises a stamping of needle bearing quality material Backing plate 66 includes reverse thrust raceway 42 that is presented toward, yet spaced from, the reverse thrust raceway 26 of the cup 2. The needle rollers 10 occupy the space between the reverse-thrust raceway 26 of the cup 2 and the reverse-thrust raceway 42 of backing plate 66. Indeed, the backing plate 66 at its raceway 42, the cup 2 at its raceway 26, and the needle rollers 10 function as a thrust bearing for transferring thrust in one direction between the cup 2 and cone 4.

In another modified bearing H (FIG. 5), bearing H includes a modified cone 70 and modified backing plate 72. Cone 70 includes an undercut 74 at its back face. Backing plate 72 includes a backing plate rib 74 that press fits into the undercut 74. Backing plate 72 includes reverse thrust raceway 42 that is presented toward, yet spaced from, the reverse thrust raceway 26 of the cup 2. The needle rollers 10 occupy the space between the reverse-thrust raceway 26 of the cup 2 and the reverse-thrust raceway 42 of backing plate 72. Indeed, the backing plate 72 at its raceway 42, the cup 2 at its raceway 26, and the needle rollers 10 function as a thrust bearing for transferring thrust in one direction between the cup 2 and cone 4.

Still further in another modified bearing I (FIG. 10A), bearing I includes a modified cone 78, a modified backing plate 80 and a locking collar 82. As shown, cone 78 includes an undercut 84 at the back face. Backing plate 80 includes a rib 86 that extends under the undercut 84 wherein the rib 86 press fits into the undercut 74. The locking collar 82 includes reverse thrust raceway 42 that is presented toward, yet spaced from, the reverse thrust raceway 26 of the cup 2. The needle rollers 10 occupy the space between the reverse-thrust raceway 26 of the cup 2 and the reverse-thrust raceway 42 of backing plate 80. Indeed, the locking collar 82 at its raceway 42, the cup 2 at its raceway 26, and the needle rollers 10 function as a thrust bearing for transferring thrust in one direction between the cup 2 and cone 4.

Other types of rolling elements such as balls or spherical rollers may be used in lieu of the needle rollers 10, with of course raceways configured to accommodate them. Moreover, the back face 22 and the reverse-thrust raceway 26 need not lie in the same plane, but the former may be offset with respect to the latter.

Additionally, means other than the formed end 40 may be employed to capture the backing plate 8 on the cone 4. For example, a nut threaded over an extended end of the cone 4 and against the backing plate 8 will suffice. Likewise, a snap ring fitted to the extended end of the cone behind the backing plate 8 may be utilized. The backing plate 8 may also be welded to the cone 4 to secure it.

The bearings A and D-I need not be tapered roller bearings, but may take the form of single row angular contact bearings. In that event, the primary rolling elements would be balls and the primary raceways on the inner and outer races would conform to them. Additionally, the bearings A and D-I have applications other then in axles for automotive vehicles, and indeed may be used where radial loads and thrust loads in both axial directions must be accommodated, but space is limited.

In view of the above, it will be seen that the several objects of the disclosure are achieved and other advantageous results are obtained. As various changes could be made in the above constructions without departing from the scope of the disclosure, it is intended that all matter contained in the above description or shown in the accompanying drawings shall be interpreted as illustrative and not in a limiting sense.

1. An antifriction bearing capable of transferring radial loads along an axis of rotation as well as thrust in both axial directions, the bearing comprising:
an outer race having a primary raceway presented inwardly toward the axis of rotation and a back face, the back face further having a reverse thrust raceway beyond a small end of the primary raceway;
an inner race having another primary raceway presented outwardly toward the primary raceway of the outer race, the inner race further having another back face that is presented axially in the direction opposite to that in which the back face of the outer race is presented;
rolling elements arranged in a single row between the primary raceways of the races;
a backing plate carried by the inner race and presented opposite the back face of the outer race, the backing plate having another reverse thrust raceway that is presented opposite the reverse thrust raceway of the back face of the outer race; and
an antifriction device located between the reverse thrust raceway of the backing plate and the reverse thrust raceway of the outer race to transfer thrust between the primary races in the axial direction that tends to unseat the rolling elements from the primary raceways.

2. The antifriction bearing of claim 1 wherein the reverse thrust raceway of the backing plate is presented toward but spaced apart from the reverse thrust raceway of the outer race.

3. The antifriction bearing of claim 1 wherein the reverse thrust raceway of the backing plate and the reverse thrust raceway of the outer race lie in planes that are perpendicular to the axis of rotation.

4. The antifriction bearing according to claim 1 wherein the antifriction device is a multitude of secondary rolling elements.

5. The antifriction bearing according to claim 4 wherein thrust applied directly to the back face of the outer race and resisted at the back face of the inner race or vice versa transfers through the secondary rolling elements along the primary races with minimal friction.

6. The antifriction bearing according to claim 4 wherein thrust applied to a front face of the outer race and resisted at a formed end of the inner race or vice versa transfers through the secondary rolling elements along the primary races with minimal friction.

7. The antifriction bearing according to claim 1 wherein the antifriction device is a washer formed from a low friction substance.

8. The antifriction bearing according to claim 7 wherein the washer is formed from phenolic resin.

9. The antifriction bearing according to claim 1 wherein the backing plate surrounds a bottom of the inner race and partially surrounds the back face of the inner race.

10. The antifriction bearing according to claim 1 further comprising a compression member that captures the backing plate against the inner race.

11. The antifriction bearing according to claim 1 wherein the inner race includes an undercut that contacts a backing plate rib.

12. The antifriction bearing according to claim 1 further comprising a locking collar positioned between the backing plate and the antifriction device.

13. An antifriction bearing capable of transferring radial loads along an axis of rotation as well as thrust in both axial directions, the bearing comprising:
an outer race having a primary raceway presented inwardly toward the axis of rotation and a back face, the back face further having a reverse thrust raceway beyond the small end of the primary raceway;
an inner race having another primary raceway presented outwardly toward the primary raceway of the outer race, the inner race further having another back face that is presented axially in the direction opposite to that in which the back face of the outer race is presented;
primary rolling elements arranged in a single row between the primary raceways of the races;
a backing plate carried by the inner race and presented opposite the back face of the outer race, the backing plate having another reverse thrust raceway that is presented opposite the reverse thrust raceway of the back face of the outer race; and
an antifriction device located between the reverse thrust raceway of the backing plate and the reverse thrust raceway of the outer race, the antifriction device comprising a multitude of secondary rolling elements wherein the multitude of secondary rolling elements transfer thrust between the primary races while minimizing friction between the primary races and the primary rolling elements.

14. The antifriction bearing according to claim 1 wherein the backing plate surrounds a bottom of the inner race and partially surrounds the back face of the inner race.

15. The antifriction bearing according to claim 1 further comprising a compression member that captures the backing plate against the inner race.

16. The antifriction bearing according to claim 1 wherein the inner race includes an undercut that contacts a backing plate rib.

17. The antifriction bearing according to claim 1 further comprising a locking collar positioned between the backing plate and the antifriction device.

18. An automotive axle comprising:
an axle housing;
an axle shaft located within the housing and extended out of one end of the housing; and
an antifriction bearing positioned within the housing, the antifriction bearing comprising
an outer race having a primary raceway presented inwardly toward the axis of rotation and a back face, the back face further having a reverse thrust raceway beyond the small end of the primary raceway;
an inner race located around the shaft, the inner race having another primary raceway presented outwardly toward the primary raceway of the outer race, the inner race further having another back face that is presented axially in the direction opposite to that in which the back face of the outer race is presented;
primary rolling elements arranged in a single row between the primary raceways of the races, the primary rolling elements being presented toward the open end of the housing;
a backing plate carried by the inner race and presented opposite the back face of the outer race, the backing plate having another reverse thrust raceway that is presented opposite the reverse thrust raceway of the back face of the outer race; and
an antifriction device located between the reverse thrust raceway of the backing plate and the reverse thrust raceway of the outer race to transfer thrust between the primary races in the axial direction that tends to unseat the primary rolling elements from the primary raceways.

19. The antifriction bearing according to claim 18 wherein the antifriction device is a multitude of secondary rolling elements.

20. The antifriction bearing according to claim 18 wherein the antifriction device is a washer formed from a low friction substance.
